(19) United States
(12) Patent Application Publication
(10) Pub. No.: US 2026/0008114 A1
(43) Pub. Date: Jan. 8, 2026

(54) SAW ACCESSORIES FOR AN OSCILLATING MULTI-TOOL

(71) Applicant: Thomas F. Wheatley, III, Sandy, UT (US)

(72) Inventor: Thomas F. Wheatley, III, Sandy, UT (US)

(21) Appl. No.: 18/762,882

(22) Filed: Jul. 3, 2024

(51) Int. Cl. B23D 61/00; B23D 61/18; B25F 3/00

(52) U.S. Cl. CPC B23D 61/006; B25F 3/00; B23D 61/185

(57) ABSTRACT

A saw accessory for an oscillating power tool includes a base having a front face and an opposing back face, a mounting hole passing through the base between the front face and the back face; two spaced apart elongated legs each having a proximal end mounted to the base and an opposing distal end, at least one of the elongated legs being movably mounted to the base; and a saw blade extending between and being removably coupled to the distal ends of the two spaced apart elongated legs.

### CROSS-REFERENCE TO RELATED APPLICATIONS

Not applicable.

### BACKGROUND

### 1. The Field of the Disclosure

The present disclosure relates to saw accessories for oscillating multi-tools and particularly to saw accessories having a coping saw blade.

### 2. The Relevant Technology

Oscillating multi-tools are well known hand-held power tools that traditionally have common means for attaching accessory tools designed for a variety of purposes such as cutting, sawing, scraping, sanding and grout removal, among others. Sawing accessories are among the most common types of attachments for oscillating multi-tools. A conventional sawing accessory typically comprises an elongated flat plate having a first end configured for attachment to the oscillating multi-tool and an opposing second end terminating at a cutting edge having cutting teeth formed thereat. During use, the oscillating multi-tool is activated causing the sawing accessory to repeatedly oscillate over a defined angle. The operator presses the oscillating cutting teeth against a surface for cutting by manually moving the oscillating multi-tool.

Although conventional sawing accessories are useful for cutting in some applications, their use is limited or precluded in other applications because of their specific configuration. That is, as with non-powered handheld saws, there are limitations on the kind of cuts that can be made with conventional sawing accessories of oscillating multi-tools. For example, coping or scribing is the woodworking technique of shaping the end of a molding or frame component to neatly fit the contours of an abutting member. Joining tubular members in metalworking is also referred to as a cope. Conventional sawing accessories of oscillating multi-tools are commonly not useful in coping or scribing due to their configuration.

Accordingly, what is needed in the art are sawing accessories for oscillating multi-tools that have improved applicability in cutting, including in coping or scribing, and/or have other improved applicability relative to conventional sawing accessories.

### DESCRIPTION OF THE DRAWINGS

FIG. 1 is a perspective view of a typical oscillating multi-tool with one embodiment of a saw accessory of the present disclosure attached thereto.

FIG. 2 is a perspective view of the saw accessory shown in FIG. 1 wherein the saw blade of the saw accessory is a coping saw blade, the teeth of which are coplanar with the base member of the accessory.

FIG. 3 is a perspective view of an alternative embodiment of the saw accessory shown in FIG. 2 where the saw blade is a coping saw blade and the teeth thereof are disposed ninety degrees to the plane of the base member of the accessory.

FIG. 4 is a perspective view of the saw accessory shown in FIG. 2 wherein the saw blade is a spiral saw blade.

FIG. 5 is an elevated front view of another alternative embodiment of a saw accessory for an oscillating multi-tool wherein the saw blade thereof is replaceable.

FIG. 6 is a perspective view of the saw accessory shown in FIG. 5.

FIG. 6A is an enlarged perspective cross sectional view of the distal end of one leg shown in FIG. 6 taken along line 6A-6A.

FIG. 7 is a perspective view of the partially disassembled distal end of the oscillating multi-tool shown in FIG. 1.

FIG. 8A is a perspective view of the oscillating multi-tool shown in FIG. 7 having the saw accessory of FIG. 6 mounted thereon.

FIG. 8B is a perspective view of the system shown in FIG. 8A with the saw accessory rotated to a different angle and the saw blade disposed adjacent thereto.

FIG. 9 is an elevated front view of a further alternative embodiment of the saw accessory shown in FIG. 5.

FIG. 10 is an elevated front view of a further alternative embodiment of the saw accessory shown in FIG. 5.

### DETAILED DESCRIPTION

Before describing the present disclosure in detail, it is to be understood that this disclosure is not limited to particularly exemplified apparatus, systems, assemblies, methods, or process parameters that may, of course, vary. It is also to be understood that the terminology used herein is only for the purpose of describing particular exemplary embodiments of the present disclosure and is not intended to limit the scope of the disclosure in any manner.

All publications, patents, and patent applications cited herein, whether supra or infra, are hereby incorporated by reference in their entirety to the same extent as if each individual publication, patent, or patent application was specifically and individually indicated to be incorporated by reference.

The term “comprising” which is synonymous with “including,” “containing,” or “characterized by,” is inclusive or open-ended and does not exclude additional, unrecited elements or method steps.

It will be noted that, as used in this specification and the appended claims, the singular forms “a,” “an” and “the” include plural referents unless the content clearly dictates otherwise. Thus, for example, reference to a “leg” includes one, two, or more legs.

In addition, unless otherwise indicated, numbers expressing quantities, constituents, distances, or other measurements used in the specification and claims are to be understood as optionally being modified by the term “about” or its synonyms. When the terms “about,” “approximately,” “substantially,” or the like are used in conjunction with a stated amount, value, or condition, it may be taken to mean an amount, value or condition that deviates by less than 20%, less than 10%, less than 5%, less than 1%, less than 0.1%, or less than 0.01% of the stated amount, value, or condition.

As used in the specification and appended claims, directional terms, such as “top,” “bottom,” “left,” “right,” “up,” “down,” “upper,” “lower,” “proximal,” “distal” and the like are used herein solely to indicate relative directions and are not otherwise intended to limit the scope of the disclosure or claims.

Where possible, like numbering of elements have been used in various figures. Furthermore, multiple instances of an element and or sub-elements of a parent element may each include separate letters appended to the element number. For example, two instances of a particular element “10” may be labeled as “10A” and “10B”. In that case, the element label may be used without an appended letter (e.g., “10”) to generally refer to all instances of the element or any one of the elements. Element labels including an appended letter (e.g., “10A”) can be used to refer to a specific instance of the element or to distinguish or draw attention to multiple uses of the element. Furthermore, an element label with an appended letter can be used to designate an alternative design, structure, function, implementation, and/or embodiment of an element. For example, two alternative exemplary embodiments of a particular element may be labeled as “10A” and “10B”. In that case, the element label may be used without an appended letter (e.g., “10”) to generally refer to all instances of the alternative embodiments or any one of the alternative embodiments.

Various aspects of the present devices and assemblies may be illustrated by describing components that are coupled, attached, and/or joined together. As used herein, the terms “coupled”, “attached”, and/or “joined” are used to indicate either a direct connection between two components or, where appropriate, an indirect connection to one another through intervening or intermediate components. In contrast, when a component is referred to as being “directly coupled”, “directly attached”, and/or “directly joined” to another component, there are no intervening elements present. Furthermore, as used herein, the terms “connection,” “connected,” and the like do not necessarily imply direct contact between the two or more elements.

Various aspects of the present devices, assemblies, and methods may be illustrated with reference to one or more exemplary embodiments. As used herein, the terms “embodiment,” “alternative embodiment” and “exemplary embodiment” mean “serving as an example, instance, or illustration,” and should not necessarily be construed as required or as preferred or advantageous over other embodiments disclosed herein.

Unless defined otherwise, all technical and scientific terms used herein have the same meaning as commonly understood by one of ordinary skill in the art to which the present disclosure pertains. Although a number of methods and materials similar or equivalent to those described herein can be used in the practice of the present disclosure, the preferred materials and methods are described herein.

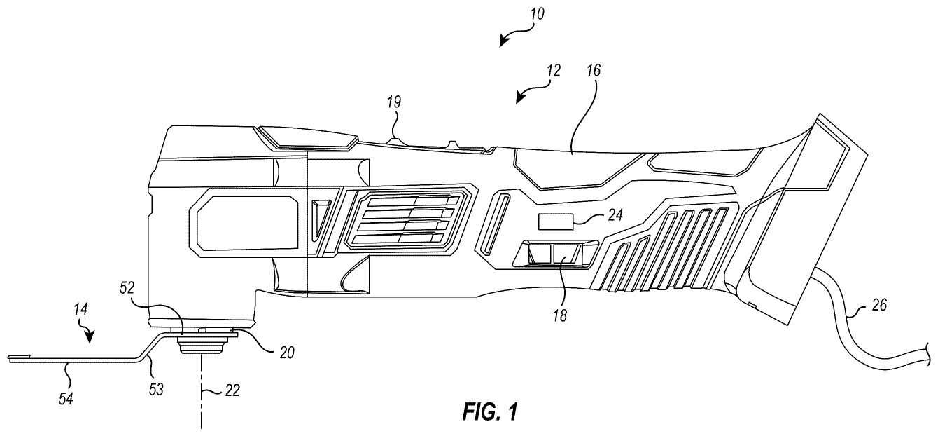

FIG. 1 illustrates one embodiment of oscillating multi-tool system 10 incorporating features of the present disclosure. Oscillating multi-tool system 10 includes an oscillating multi-tool 12 having a saw accessory 14 removably mounted thereon. In general, oscillating multi-tool 12 includes a body 16 that houses a motor 18. Motor 18 is activated by a switch 19 disposed on body 16. A rotor 20 is coupled with motor 18 and projects from body 16. Rotor 20 is coupled with motor 18 so that when motor 18 is activated, rotor 20 rotatably oscillates about an axis of rotation 22 over a defined angle. For example, rotor 20 can rotatably oscillate over an angle that is typically at least 5°, 10°, 15°, 20° 30° or 40° or is in a range between any two of the foregoing but is commonly less than 90°. The angle of rotation is typically fixed but the rate of rotatable oscillation can typically be controlled by an operator by manually adjusting a regulator 24 disposed on body 16. Motor 18 can be energized either through an electrical cable 26 extending from body 16 or by coupling a battery to body 16.

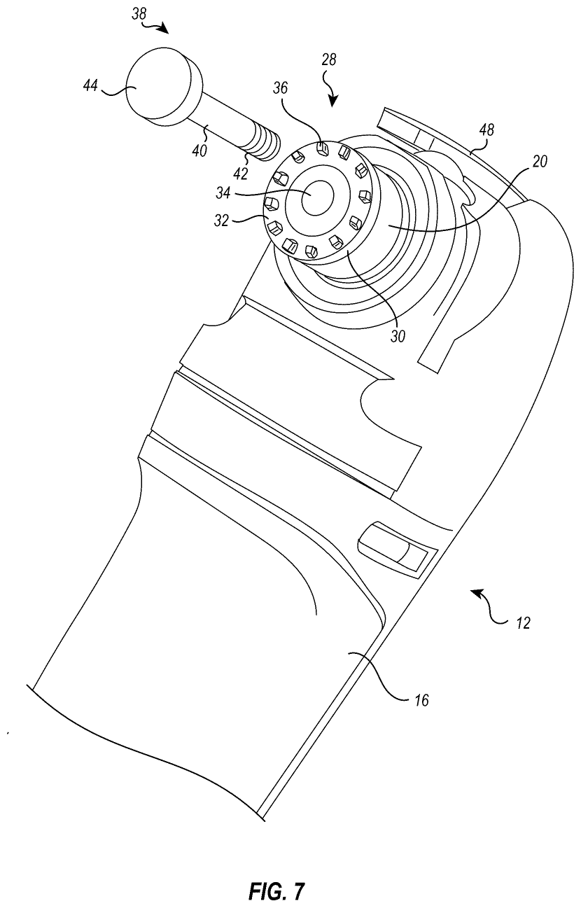

In general, oscillating multi-tool 12 is configured so that a variety of different accessories, such as various forms of tools produced by different manufactures, can be removably attached to rotor 20. As a result of the attachment, the accessories/tools rotatably oscillate concurrently with rotor 20. For example, as depicted in FIG. 7, in one embodiment oscillating multi-tool 12 further comprises a coupler 28 at least partially disposed on rotor 20. Coupler 28 includes a mount 30 disposed on or integrally formed with rotor 20 and having an exposed end face 32 with a retention opening 34 centrally formed thereon. A plurality of alignment projections 36 outwardly project from end face 32 at radially spaced apart locations from retention opening 34. Projections 36 are disposed so as to radially encircle retention opening 34. Coupler 28 also includes a locking pin 38 having a shaft 40 with a first end on which annular engaging ribs 42 are formed and an opposing second end with an enlarged head 44 disposed thereat.

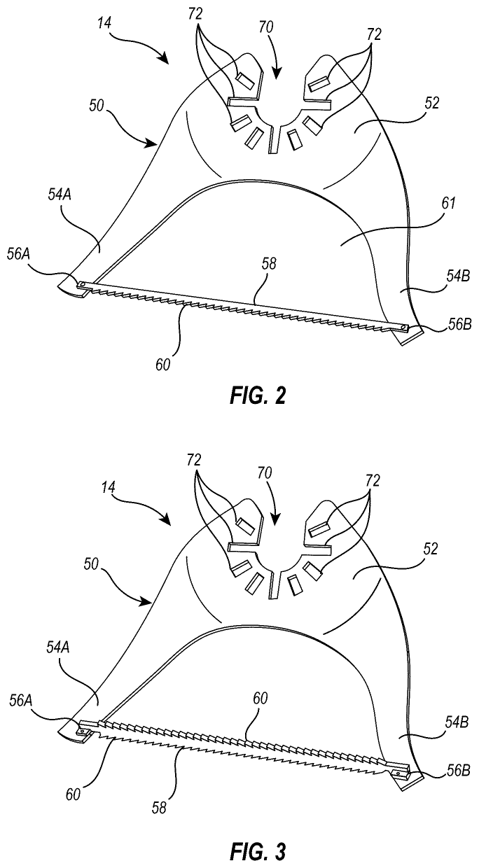

During use, as will be discussed below in more detail, saw accessory 14 (FIG. 2) is disposed on end face 32 so as to mesh with projections 36. A lever 48 disposed on body 16 is moved to an unlocked position and shaft 40 of locking pin 38 is passed into retention opening 34 until head 44 presses against saw accessory 14. Lever 48 is then moved into a locking position which results in shaft 40 (and particularly ribs 42) being engaged within body 16 so that locking pin 38 is secured in place. The combination of projections 36 and locking pin 36 secure saw accessory 14 to rotor 20. Oscillating multi-tools having the configuration of oscillating multi-tool 12 with coupler 28, as disclosed above, are produced by Makita U.S.A., Inc. and are known in the art. However, in alternative embodiments, coupler 28 can have other figurations. For example, in contrast to using removable locking pin 38 with retention opening 34, coupler 28 can be configured with an expandable extension that extends out from opening 24 and that engages directly with saw accessory 14. Other configurations for coupler 28 can also be used. For example, other configurations for couplers are used on oscillating multi-tools produced under the tradenames DEWALT, MILWAUKEE, BOSCH, KOBALT and RIDGID and are known in the art.

FIG. 2 is a perspective view of saw accessory 14. Saw accessory 14 comprises a flat rigid body 50 that includes an attachment base 52 and a pair of spaced apart elongated legs 54A and 54B that extend, e.g., outwardly project, from attachment base 52. Legs 54A and 54B typically project so as to have a substantially U or V shaped configuration. In the depicted embodiment, legs 54A and 54B are integrally formed with attachment base 52 but alternatively can be removably mounted thereto. Legs 54A and 54B each terminate at a distal end 56A and 56B, respectively. A saw blade 58, such as a coping saw blade, extends between distal ends 56A and 56B of legs 54A and 54B, respectively. The ends of saw blade 58 can be secured to legs 54A and 54B by welding, pining, or other conventional techniques. Thus, saw blade 58 can be permanently or removably secured to legs 54A and 54B. Further disclosure on saw blade 58 is provided below. As a result of the above configuration, an opening 61 is formed/bounded between legs 54A and 54B and by blade 58.

In one embodiment, as shown in FIG. 2, body 50 of saw accessory 14 can be planar so that legs 54A and 54B are disposed in the same plane as attachment base 52. In an alternative configuration, as shown in FIG. 1, a sloped or curved transition 53 can be formed extending between legs 54A and 54B and attachment base 52 so that legs 54A and 54B and attachment base 52 are not disposed in the same plane. For example, legs 54A and 54B and attachment base 52 can be disposed in parallel planes that are offset.

Saw blade 58 may be attached so that teeth 60 of saw blade 58 are coplanar with a plane of body 50/legs 54A and 54B and extend outwardly from body 50. Alternatively, as shown in FIG. 3, saw blade 58 may be attached so that the teeth 60 extend in a direction ninety degrees to the plane of body 50/legs 54A and 54B. In this latter configuration, teeth 60 can be formed along only one edge of saw blade 58 or along both opposing edges of saw blade 58, as shown in FIG. 3.

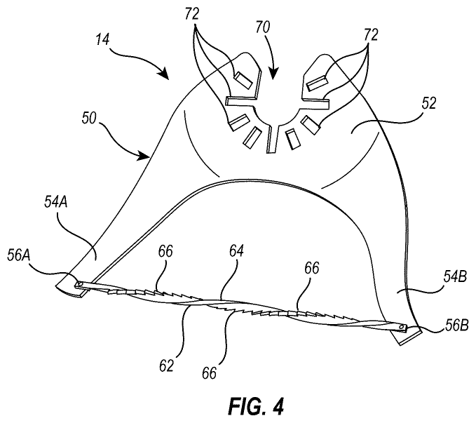

In another alternative embodiment as illustrated in FIG. 4, the saw blade may be a spiral saw blade 62 extending between legs 54A and 54B. For example, spiral saw blade 62 can comprise a taut wire 64 attached at each of its terminal ends to distal ends 56A and 56B of the legs 54A and 54B, respectively. Spiraling around wire 64 are a series of saw teeth 66. Alternatively, spiral saw blade 62 can simply comprise saw blade 58 as shown in FIG. 2 or 3 spirally twisted.

Returning to FIG. 2, centrally extending through attachment base 52 of body 50 is a mounting opening 70. Mounting opening 70 is depicted as being U-shaped. However, in alternative embodiments, it can be an enclosed circular configuration or a C-shaped configuration, as further discussed below. Also extending through attachment base 52 are a plurality of spaced apart alignment holes 72. Alignment holes 72 are radially spaced apart from mounting opening 70 so as to be radially spaced around mounting opening 70. More specifically, with reference to FIGS. 2 and 7, attachment base 52 is configured so that attachment base 52 can sit flat against end face 32 of coupler 28 with mounting opening 70 of attachment base 52 being aligned with retention opening 34 of coupler 28 and with projections 36 of coupler 28 being received within alignment holes 72. In this configuration, locking pin 38 can be passed through aligned openings 70 and 36 so that head 44 butts against the front face of attachment base 52. Locking pin 38 is then locked in place using lever 48, as discussed above, thereby securing saw accessory 14 to rotor 20/coupler 28. Here it is noted that saw accessory 14 can be secured to coupler 28 at a variety of different angular orientations by simply rotating saw accessory 14 relative to end face 32 during the attachment phase so that projections 36 are disposed within different ones of alignment holes 72. Thus, saw accessory 14 can be positioned at different orientations on oscillating multi-tool 12 depending on desired use.

Once, saw accessory 14 is secured to oscillating multi-tool 12, oscillating multi-tool 12 can be activated to facilitate rapid rotatable oscillation of saw accessory 14, as previously discussed. In turn, the now oscillating saw accessory 14 can be used to easily cut/sculpture a structure so as to have a desired configuration. Specifically, by manually manipulating oscillating multi-tool 12, the operator can press oscillating saw blade 58 against a structure for cutting. Because saw blade 58 is oscillating, saw blade easily cuts the structure with minimal force from the operator. Furthermore, because saw blade 59 is freely suspended between the distal ends of legs 54A and 54B, similar to the configuration of a conventional manual coping saw, saw accessory 14 can be used to make intricate and curved cuts, such as coping or scrolling cuts, the same as a coping saw. In such cuts, a portion of the structure being cut may pass through or extend into opening 61 of saw accessory 14. As needed, saw accessory 14 can be adjusted to be mounted at any desired angle on oscillating multi-tool 12, as discussed above, to further assist in making intricate or awkward cuts.

Furthermore, the unique configuration of saw accessory 14 having saw blade 58 suspended between separated legs 54A and 54B and having enlarged opening 61 passing therethrough adjacent to saw blade 58 enables saw accessory 14 to make other types of cuts that would otherwise be difficult or impossible to make. For example, it is not uncommon to have a situation where a hole or cavity exists that extends to a floor. A structure, such as a pipe, rod, column, board, frame, or other structure, can project out from the floor toward an opening of the hole or cavity. However, where the hole or cavity has a relatively small diameter encircling the structure, it can be difficult or impossible to cut off a free end of the structure located within the hole or cavity using a conventional hand saw or a conventional saw accessory without substantially increasing the diameter of the hole or cavity. By using saw accessory 14, however, the operator can easily advance saw blade 58 into the hole or cavity along the side of the structure by holding oscillating multi-tool 12. With oscillating multi-tool 12 activated, the operator can then simply press the oscillating saw blade 58 against the side of the structure so saw blade 58 cuts laterally through the structure while the free distal end of the structure passes through opening 61 of saw accessory 14, thereby cutting off the distal end of the structure. The process can be repeated until a sufficient length of the structure within the hole or cavity has been removed. It is appreciated that other unique cuts can also be made by saw accessory 14.

Another advantage of saw accessory 14 is that it has a simple design and is relatively inexpensive to produce. Thus, once saw blade 58 is no longer sharp or where it is broken, saw accessory 14 can simply be replaced with a new saw accessory.

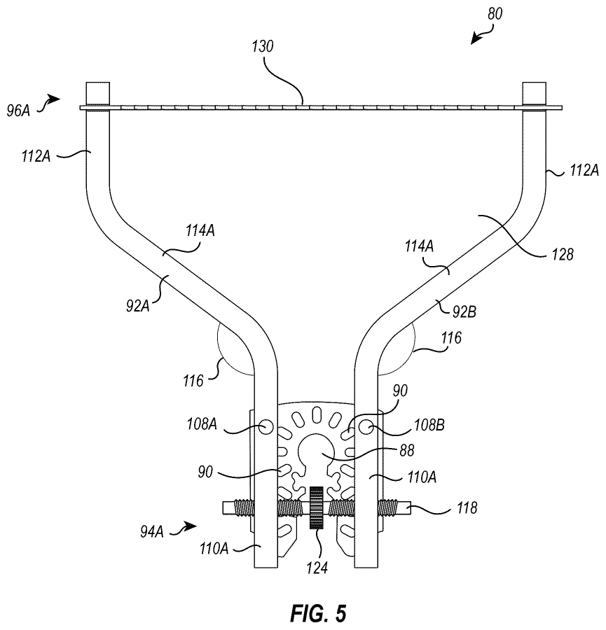

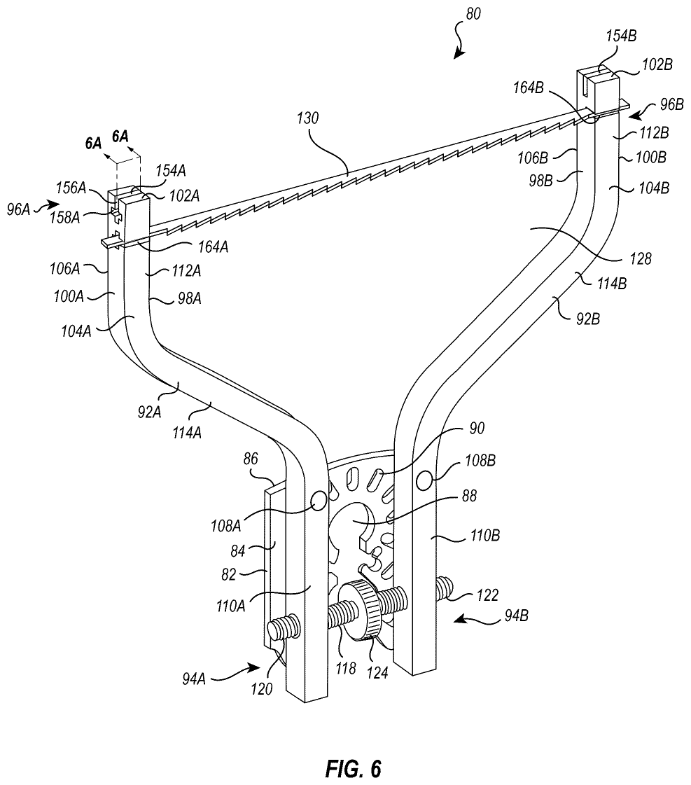

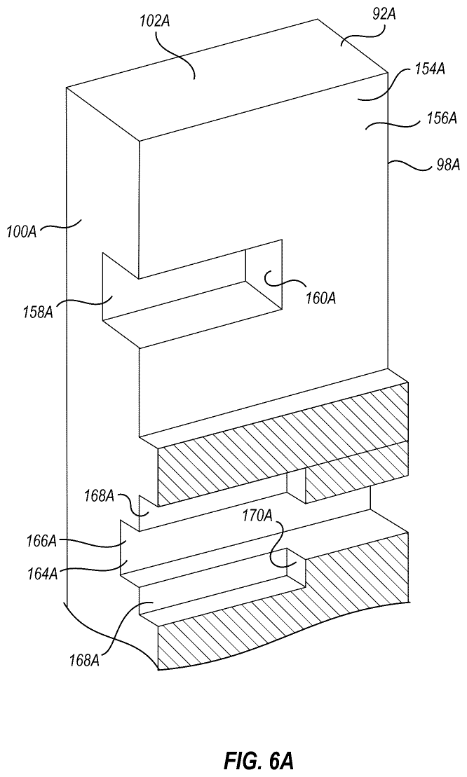

Depicted to FIGS. 5 and 6 is another alternative embodiment of a saw accessory 80 which incorporates features of the present disclosure and that can be removably mounted to and operated by oscillating multi-tool 12. Like elements between saw accessory 14 and saw accessory 80 are identified by like reference numbers. Saw accessory 80 comprises an attachment base 82, typically in the form of a plate, that has a front face 84 and an opposing back face 86. Extending through attachment base 82 between faces 84 and 86 is a mounting opening 88. Mounting opening 88 can be centrally formed on attachment base 82 and in the depicted embodiment has a C-shaped configuration. In alternative embodiments, mounting opening 88 can have a U-shaped configuration, such as mounting opening 70 shown in FIG. 2, or can have a closed circular shape, such as depicted in later embodiments. Other configurations can also be used. Also extending through attachment base 82 between faces 84 and 86 is a plurality of spaced apart alignment holes 90. Alignment holes 90 are radially spaced apart from mounting opening 88 so as to be radially spaced around mounting opening 88. Alignment holes 90 are typically smaller than mounting opening 88. The number of alignment holes 90 is typically at least 3, 5, 7, 9, 12 or 20 or in a range between any two of the forgoing. Other numbers can also be used.

Saw accessory 80 also comprises a pair of elongated legs, i.e., a first leg 92A and a spaced apart second leg 92B. First leg 92A longitudinally extends between a proximal end 94A and an opposing distal end 96A. First leg 92A also includes an inside face 98A and an opposing outside face 100A that each extend to a terminal end face 102A. Opposing side faces 104A and 106A extend between inside face 98A and outside face 100A and also extend to terminal end face 102A. In the depicted embodiment, first leg 92A has a square or rectangular transverse cross section. However, in alternative embodiments the cross section can be circular, elliptical, polygonal, irregular, or have other configurations.

In one embodiment, first leg 92A can also be defined as comprising a proximal portion 110A that is linear and secured to attachment base 82, a distal portion 112A that is linear and extends parallel to proximal portion 110A, and a central portion 114A extending between proximal portion 110A and distal portion 112A. Central portion 114A slopes outward away from proximal portion 110A/attachment base 82 as it extends to distal portion 112A. In one embodiment an inside angle 116 extending between proximal portion 110A and central portion 114A is equal to or less than 160°, 145°, 130°, 105° or 90° or is in a range between any two of the foregoing. Angle 116 is typically greater than 90°. Similar inside angles can also be formed between central portion 114A and distal portion 112A. First leg 92A can also have other configurations. For example, one or each of proximal portion 110A, central portion 114A, and distal portion 112A can be curved or comprise multiple separate sections that are angled together.

First leg 92A is movably mounted to attachment base 82 and in the depicted embodiment is pivotally mounted to attachment base 82. Specifically, a fastener 108A extends between first leg 92A and attachment base 82 that secures first leg 92A to attachment base 82 and allows first leg 92A to pivot relative to attachment base 82 about or with fastener 108A. Fastener 108A can comprise a bolt, rivet, screw, shaft, pin, spindle or other structure that will facilitate the function.

Second leg 92B is the mirror image of first leg 92A and is typically disposed adjacent to first leg 92A so that legs 92 are symmetrically disposed. As such, the above discussion and alternatives with regard to first leg 92A are also applicable to second leg 92B. Furthermore, like elements between first leg 92A and second leg 92B are identified by like reference characters except that the elements of second leg 92B include the suffix “B” rather than “A.” Second leg 92B is also movably mounted to attachment base 82 and in the depicted embodiment is pivotally mounted to attachment base 82. Specifically, a fastener 108B extends between second leg 92B and attachment base 82 that secures second leg 92B to attachment base 82 and allows second leg 92B to pivot relative to attachment base 82 about or with fastener 108B. Fastener 108B can also comprise a bolt, rivet, screw, shaft, pin, spindle or other structure that will facilitate the function.

First leg 92A and second leg 92B are secured to attachment base 82 on opposing sides of mounting opening 88. The present disclosure also includes means for moving at least one of first leg 92A or second leg 92B relative to attachment base 82 so as to adjust the distance between the distal ends of the legs 92A and 92B. By way of example and not by limitation, an adjustment shaft 118 is provided having a threaded first end 120 that threadedly engages with proximal end 94A of first leg 92A and an opposing threaded second end 122 that threadedly engages with proximal end 94B of second leg 92B. The threads at second end 122 are reversed relative to the threads at first end 120 so that when adjustment shaft 118 is rotated, proximal ends 94A and 94B are either drawn together or are separated apart depending on the direction of rotation of adjustment shaft 118. In the depicted embodiment, adjustment shaft 118 is disposed on legs 92A and 92B proximal of fasteners 108A and 108B. As such, as proximal end 94A and 94B are drawn together by adjustment shaft 118, distal end 96A and 96B of legs 92A and 92B, respectively, are separated apart whereas when proximal ends 94A and 94B are separated apart by adjustment shaft 118, distal end 96A and 96B of legs 92A and 92B, respectively, are drawn towards each other.

Optionally mounted on adjustment shaft 118 is a control knob 124 used in rotating adjustment shaft 118. In the depicted embodiment control knob 124 is centrally mounted on adjustment shaft 118 between legs 92A and 92B. Control knob 124 can comprise a circular thumb wheel that can be manually rotated to rotate adjustment shaft 118. In other embodiments, control knob 124 can have a polygonal configuration or have opposing flats formed thereon so that it can be engaged and rotated by a tool, such as a wrench. In still other embodiments, control knob 124 can be disposed at one of the opposing ends of adjustment shaft 118 and be configured for manual rotation or for engaging with a tool such as a screwdriver, wrench, Allen wrench, or the like. Control knob 124 can also have other configurations such the configuration of wings on a wing nut. In other embodiments, control knob 124 can be eliminated and adjustment shaft 118 can be directly formed with flats, a socket, a slot, or have other configurations for receiving a tool such as a screwdriver, wrench, Allen wrench, or the like for rotating adjustment shaft 118. Alternative embodiments of the means for moving at least one of first leg 92A or second leg 92B are discussed below.

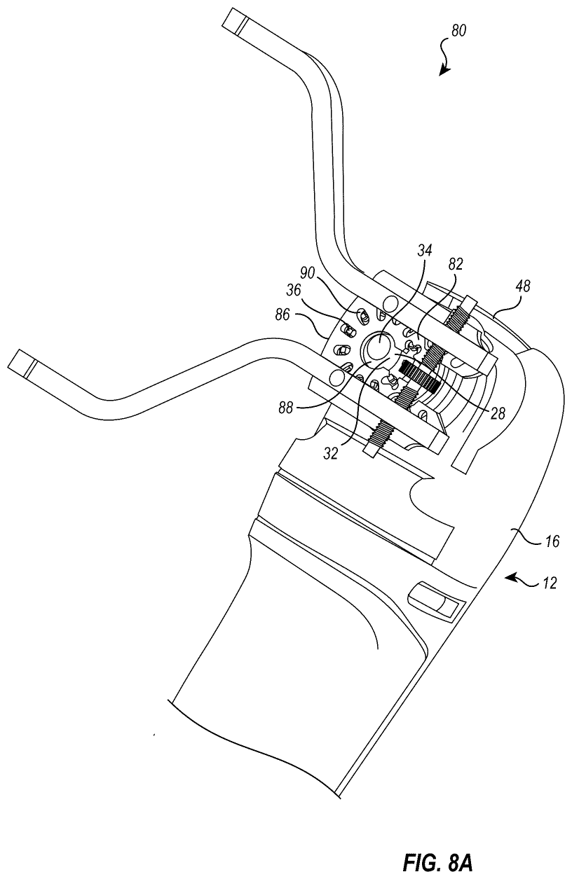

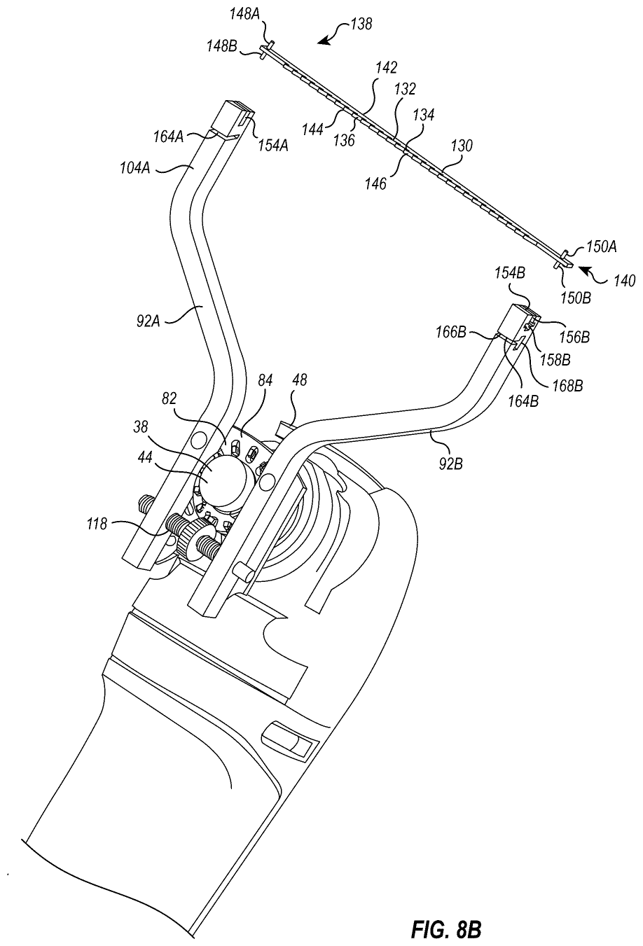

The above discussed movement of legs 92A and 92B using adjustment shaft 118 is for mounting or removing a saw blade 130 from distal ends 96A and 96B of legs 92A and 92B, respectively. Turning to FIG. 8B saw blade 130 comprises an elongated blade body 132 having a first side face 134 and a second side face 136 that longitudinally extend between a first end 138 and an opposing second end 140 and that laterally extend between a back edge 142, which is typically linear, and an opposing cutting edge 144. A plurality of cutting teeth 146 are formed along a least a majority of a length of cutting edge 144. Blade body 132 can also be formed having cutting teeth 146 formed along back edge 142, such as shown in FIG. 3, or can be spiral as shown and discussed in association with FIG. 4. Other configurations can also be used.

Saw blade 130 also includes a first pin 148A outwardly projecting from first side face 134 at first end 138 and a second pin 148B outwardly projecting from second side face 136 at first end 138. Pins 148A and 148B are in alignment and can comprise one continuous pin that extends through blade body 132 or two sperate pins secured to blade body 132. Likewise, a first pin 150A outwardly projects from first side face 134 at second end 140 and a second pin 150B outwardly projects from second side face 136 at second end 140. Again, pins 150A and 150B are in alignment and can comprise one continuous pin that extends through blade body 132 or two sperate pins secured to blade body 132. In one embodiment, saw blade 130 can comprise a conventional coping saw blade.

Pins 148 and 150 are used to removably secure saw blade 130 to legs 92A and 92B. More specifically, with reference to FIGS. 6, 6A, and 8B, a first slot 154A is shown recessed into terminal end face 102A of first leg 92A and passing between inside face 98A and outside face 100A. First slot 154A comprises a lateral slot 156A and a transverse slot 158A. Lateral slot 156A is recessed into terminal end face 102A of first leg 92A and passes between inside face 98A and outside face 100A. Transverse slot 158A is recessed into outside face 100A so as to intersect with lateral slot 156A in a cross configuration. Transverse slot 158A does not pass completely through first leg 92A but rather terminates at an end wall 160A within first leg 92A. Lateral slot 156A is sized to receive blade body 132 while transverse slot is configured to receive pins 148A and 148B.

A first slot 154B is formed on distal end 96B of second leg 92B and comprises a lateral slot 156B and a transverse slot 158B. First slot 154B has the same configuration and elements as first slot 154A and is formed in the same manner on second leg 92B as first slot 154A is formed on first leg 92A. Like elements between first slot 154A and first slot 154B are identified by like reference numbers except that the elements of first slot 154B include the suffix “B”.

During use, adjustment shaft 118 is rotated in a first direction to drawn opposing distal ends 96A and 96B of legs 92A and 92B, respectively, closer together. First end 138 and second end 140 of saw blade 130 are then secured within first slot 154A and first slot 154B, respectively. Specifically, first end 138 of blade body 132 is received within lateral slot 156A of first leg 92A so that pins 148A and 148B are received within transverse slot 158A while second end 140 of blade body 132 is received within lateral slot 156B of second leg 92B so that pins 150A and 150B are received within transverse slot 158B. Adjustment shaft 118 is then rotated in a second direction opposite the first direction so as to separate distal ends 96A and 96B of legs 92A and 92B until saw blade 130 is sufficiently tensioned between legs 92A and 92B. That is, as legs 92A and 92B are separated, ends 138 and 140 of saw blade 130 remain captured therein by pins 148 and 150 biasing against corresponding end walls 160 of transverse slots 158A and 158B. When saw blade 130 needs to be replaced, distal ends 96 of legs 92A and 92B can again be drawn together which enables saw blade 130 to be removed and replaced with a new saw blade 130.

By inserting saw blade 130 within first slots 154A and 154B, saw blade 130 is disposed coplanar with legs 92. Expressed in other terms, teeth 146 of saw blade 130 are aligned so as to face distally of distal end faces 102. Legs 92A and 92B are also configured so that saw blade 130 can be mounted thereto so that saw blade 130 is disposed perpendicular to the plane of legs 92, i.e., cutting teeth of saw blade 130 are aligned so as to face laterally away from side face 104. Specifically, as shown in FIGS. 6, 6A and 8B, a second slot 164A is shown recessed into side face 104A of first leg 92A and passing between inside face 98A and outside face 100A. Second slot 164A also comprises a lateral slot 166A and a transvers slot 168A. Lateral slot 166A is recessed into side face 104A of first leg 92A and passes between inside face 98A and outside face 100A. Transverse slot 168A is recessed into outside face 100A so as to intersect with lateral slot 166A in a cross configuration. Transverse slot 168A does not pass completely through first leg 92A but rather terminates at an end wall 170A within first leg 92A. Lateral slot 166A is sized to receive blade body 132 while transverse slot 168A is configured to receive pins 148A and 148B.

A second slot 164B is formed on distal end 96B of second leg 92B and comprises a lateral slot 166B and a transverse slot 168B. Second slot 164B has the same configuration and elements and second slot 164A and is formed in the same manner on second leg 92B as on first leg 92A. Like elements between second slot 164A and second slot 164B are identified by like reference numbers except that the elements of second slot 164B include the suffix “B”. Saw blade 130 can be inserted into second slots 164A and 164B and tensioned therein, as shown in FIG. 6, in the same manner as discussed above with regard mounting saw blade 130 within first slots 154A and 154B.

In one embodiment, saw blade 130 can be selectively secured within first slots 154 or second slots 164 based on the desired orientation of saw blade 130 for cutting. In alternative embodiments, legs 92 can be formed with just first slots 154A and 154B or just second slots 164A and 164B. In still other embodiments, first slots 154 and/or second slots 164 can be disposed at other angles/orientations.

Turning to FIG. 8A, when mounting saw accessory 80 to oscillating multi-tool 12, before or after attachment of saw blade 130 (FIG. 8B), back face 86 of attachment base 82 is disposed against end face 32 of coupler 28 so that mounting opening 88 is aligned with retention opening 34 and projections 36 are received within select alignment holes 90. Saw accessory 80 can be disposed at any desired angle on coupler 28 as long as projections 36 are received within alignment holes 90. For example, FIGS. 8A and 8B show saw accessory 80 being disposed on coupler 28 in two different angular orientations relative to end face 32 of coupler 28/oscillating multi-tool 12. Other orientations can also be used depending on the desired orientation for use.

As previously discussed, with saw accessory 80 disposed against end face 32 of coupler 28 and lever 48 in a released position, locking pin 38 (FIG. 7) is advanced down through aligned openings 88 and 34 until head 44 bias against front face 84 of attachment base 82, as shown in FIG. 8B. Lever 48 is then moved to the locking position which secures locking pin 38 in place and thereby secures saw accessory 80 to oscillating multi-tool 12. Oscillating multi-tool 12 can then be activated causing saw accessory 80 and particularly saw blade 130 to rapidly oscillate. While saw blade 130 is oscillating, the operator can manipulate oscillating multi-tool 12 so as to press saw blade 130 against a surface for cutting.

Saw accessory 80 can have the same benefits for cutting and use as previously discussed with regard to saw accessory 14. For example, saw accessory includes an opening 128 bounded directly between legs 92A and 92B and directly bounded by saw blade 130. This configuration enables saw accessory 80 to make intricate and/or curved coping or scroll cuts wherein a portion of the structure being cut can pass into or through opening 128. Cuts within holes and cavities, as previously discussed, can also be made. The other benefits discussed with regard to saw accessory 14 are also applicable to saw accessory 80. In addition, saw accessory 80 has unique benefits. For example, saw blade 130 can be replaced when dull or broken while retaining the reminder of saw accessory 80. In addition, saw blade 130 can be replaced with different configurations of saw blades depending upon use. For example, saw blades with larger or smaller teeth or teeth made of different materials can be used. Furthermore, in some designs, saw blade 130 can be moved to different slots so as to have different orientations depending on desired use. Other benefits also exist.

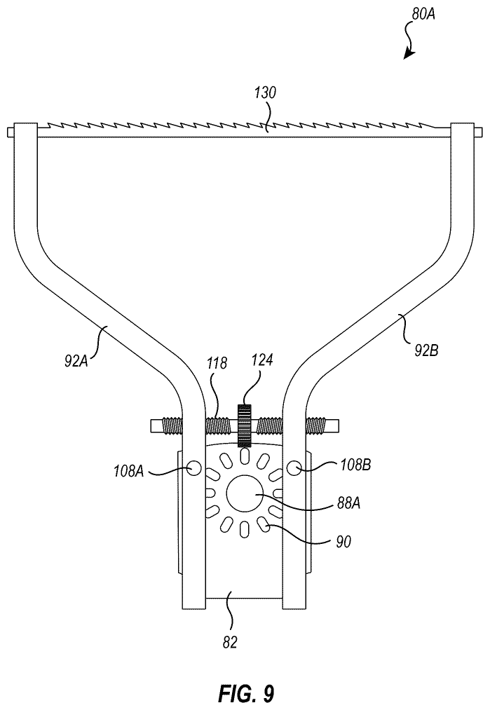

The saw accessories of the present disclosure can also have a variety of other modifications or alternative configurations. For example, depicted in FIG. 9 is a saw accessory 80A. Like elements between saw accessories 80 and 80A are identified by like reference numbers and, unless noted otherwise, all of the elements, uses, alternatives, and benefits as discussed above with regard to saw accessory 80 are also applicable to saw accessories 80A. Initially, saw accessory 80A differs from saw accessory 80 in that saw accessory 80A includes a mounting opening 88A extending through attachment base 82 that is circular as opposed to U or C shaped. In addition, alignment holes 90 can radially extend at encircling positions around mounting opening 88A. This configuration provides greater versatility in the different orientations that saw accessory 80 can be mounted on oscillating multi-tool 12. Furthermore, in contrast to adjustment shaft 118 being disposed proximal of fasteners 108 and mounting opening 88A, in saw accessory 80A adjustment shaft 118 extends between legs 92A and 92B distal of fasteners 108 and mounting opening 88A. This configuration changes the direction of rotation of adjustment shaft 118 that separates or draws together the distal ends of legs 92. The configuration also helps limit any obstruction of mounting opening 88A and alignment holes 90 which can be beneficial during mounting on oscillating multi-tool 12.

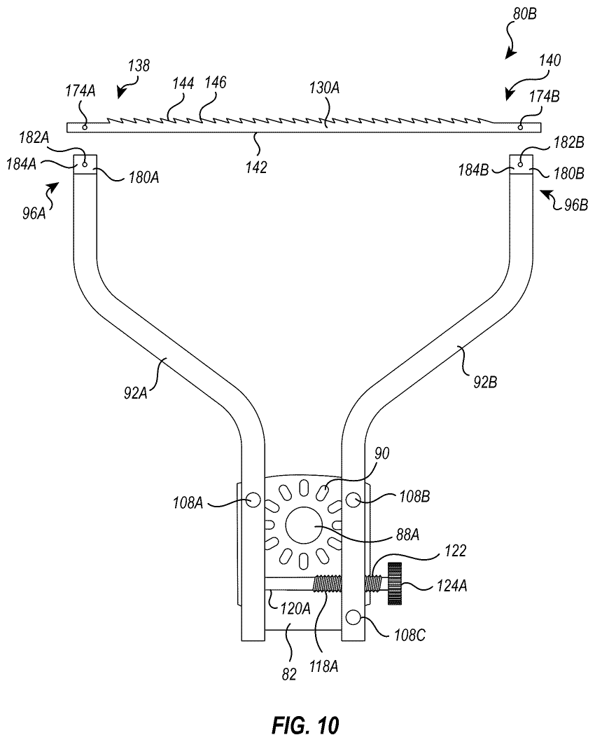

Depicted in FIG. 10 is a saw accessory 80B. Like elements between saw accessories 80, 80A, and 80B are identified by like reference numbers and unless noted otherwise, all of the elements, uses, alternatives, and benefits as discussed above with regard to saw accessories 80 and 80A are also applicable to saw accessory 80B. In both saw accessories 80 and 80A, both legs 92A and 92B could pivot relative to attachment base 82 about respective fasteners 108A and 108B. However, in saw accessory 80B, second leg 92B is fixed relative to attached base 82. In the depicted embodiment, this is accomplished by using a further fastener 108C spaced apart from fastener 108B to further secure second leg 92B to attachment base 82. In alternative embodiments, second leg 92B can be fixedly secured to attached base 82 by being welded, adhered, clamped, crimped, integrally formed therewith or otherwise secured thereto. In this embodiment, an adjustment shaft 118A is used to control movement of first leg 92A relative to attachment base 82 for removal and mounting of a saw blade.

Adjustment shaft 118A has a first end 120A that is rotatably secured to the proximal end of first leg 92A and an opposing threaded second end 122 that passes through and is threadedly coupled with second leg 92B. An optional control knob 124A is mounted on second end 122 of adjustment shaft 118A and can have the same alternative configurations as previously discussed with regard to control knob 124 for use in rotating adjustment shaft 118A. As adjustment shaft 118A is rotated, adjustment shaft 118A either pushes the proximal end of first leg 92A away from second leg 92B or toward second leg 92B, thereby adjusting the distance between the opposing distal ends of legs 92A and 92B. As with saw accessory 80A, adjustment shaft 118A can also be disposed extending between legs 92A and 92B at a location distal of fasteners 108A and 108B/mounting opening 88A. Adjustment shaft 118A is another alternative example of the means for moving at least one of first leg 92A or second leg 92B, as previously discussed.

Although saw blade 130 can be mounted on the distal ends of legs 92A and 92B the same way as previously discussed with regard to saw accessories 80 and 80A, saw accessory 80A is depicted as comprising saw blade 130A. Like elements between saw blades 130 and 130A are identified by like reference numbers. Saw blades 130 and 130A are the same except that saw blade 130A does not include pins 148 and 150 (FIG. 8B) but rather includes a hole 174A extending through first end 138 and a hole 174B extending through second end 140. Distal ends 96A and 96B of legs 92A and 92B are configured to removably couple with the opposing ends of saw blade 130A. Specifically, a notch 180A is formed at distal end 96A of leg 92A so as to reveal a side face 184A thereat. A catch 182A laterally outwardly projects from side face 184A. Catch 182A can comprise a pin, hook, or other structure configured to pass into hole 174A and thereby releasably engage first end 138 of saw blade 130A.

Distal end 96B of leg 92B has the same configuration as distal end 96A of leg 92A and like elements are identified by like reference numbers except that the reference numbers of distal end 96B include the suffix “B”. As such distal ends 96A and 96B of legs 92A and 92B, respectively, can securely engage the opposing ends of saw blade 130A while adjustment shaft 118A can be used in the tensioning or replacement of saw blade 130A. In alternative embodiments, it is appreciated that other mechanical couplings can be used to couple distal ends 96A and 96B of legs 92A and 92B to the opposing ends of a saw blade.

As discussed above, the different embodiments disclosed herein have different structural elements and/or configurations. The present disclosure also envisions and covers other alternative embodiments where the elements and configurations of the disclosed embodiments are freely mixed and matched.

The saw accessories of the present disclosure provide unique advantages in that they can each achieve one or more or the following. They can be mounted on an oscillating multi-tool so that the saw blade can be oscillated to produce easy cutting. They can be mounted on the oscillating multi-tool in a variety of different orientations to produce optimal positioning of the saw blade for optimal cutting. The tension on the saw blades can be adjusted and the saw blades can be replaced, such as when a saw blade is worn or broken or when it is desired to use a different configuration of saw blade. The saw accessories are uniquely configured to make intricate and curved cuts, such as coping or scrolling cuts, the same as a coping saw. In such cuts, a portion of the structure being cut may pass through or extend into an opening of the saw accessory. Such cuts would be difficult or not possible by a convention saw accessory. Other advantages and benefits also exist.

Various alterations and/or modifications of the inventive features illustrated herein, and additional applications of the principles illustrated herein, which would occur to one skilled in the relevant art and having possession of this disclosure, can be made to the illustrated embodiments without departing from the spirit and scope of the invention as defined by the claims, and are to be considered within the scope of this disclosure. Thus, while various aspects and embodiments have been disclosed herein, other aspects and embodiments are contemplated. While a number of methods and components similar or equivalent to those described herein can be used to practice embodiments of the present disclosure, only certain components and methods are described herein.

It will also be appreciated that systems, processes, and/or products according to certain embodiments of the present disclosure may include, incorporate, or otherwise comprise properties features (e.g., components, members, elements, parts, and/or portions) described in other embodiments disclosed and/or described herein. Accordingly, the various features of certain embodiments can be compatible with, combined with, included in, and/or incorporated into other embodiments of the present disclosure. Thus, disclosure of certain features relative to a specific embodiment of the present disclosure should not be construed as limiting application or inclusion of said features to the specific embodiment. Rather, it will be appreciated that other embodiments can also include said features without necessarily departing from the scope of the present disclosure.

Moreover, unless a feature is described as requiring another feature in combination therewith, any feature herein may be combined with any other feature of a same or different embodiment disclosed herein. Furthermore, various well-known aspects of illustrative assemblies, processes, products, and the like are not described herein in particular detail in order to avoid obscuring aspects of the example embodiments. Such aspects are, however, also contemplated herein.

The present disclosure may be embodied in other specific forms without departing from its spirit or essential characteristics. The described embodiments are to be considered in all respects only as illustrative and not restrictive. The scope of the invention is, therefore, indicated by the appended claims rather than by the foregoing description. While certain embodiments and details have been included herein and in the attached disclosure for purposes of illustrating embodiments of the present disclosure, it will be apparent to those skilled in the art that various changes in the methods, products, devices, and apparatus disclosed herein may be made without departing from the scope of the disclosure or of the invention, which is defined in the appended claims. All changes which come within the meaning and range of equivalency of the claims are to be embraced within their scope.

What is claimed is:

1. A saw accessory for an oscillating multi-tool, comprising:
an attachment base having a front face and an opposing back face, a mounting opening passing through the attachment base between the front face and the back face;
two spaced apart elongated legs each having a proximal end mounted to the attachment base and an opposing distal end, at least one of the elongated legs being movably mounted to the attachment base; and
a saw blade extending between and being removably coupled to the distal ends of the two spaced apart elongated legs.

2. The saw accessory as recited in claim 1, further comprising means for moving the at least one of the two elongated legs relative to the base so as to adjust a distance between the distal ends of the elongated legs.

3. The saw accessory as recited in claim 1, further comprising an adjustment shaft coupled to at least one of the two elongated legs, wherein rotation of the adjustment shaft causes movement of at least one of the two elongated legs.

4. The saw accessory as recited in claim 3, wherein the adjustment shaft has a first end threadedly coupled to a first one of the two elongated legs and an opposing second end threadedly coupled to a second one of the two elongated legs.

5. The saw accessory as recited in claim 4, further comprising a knob disposed on and outwardly projecting from the adjustment shaft.

6. The saw accessory as recited in claim 4, wherein both of the two elongated legs are pivotably mounted to the base.

7. The saw accessory as recited in claim 4, further comprising a plurality of alignment holes extending through the base between the front face and the opposing back face, each of the plurality of alignment holes being radially spaced apart from the mounting opening.

8. The saw accessory as recited in claim 1, further comprising:
each of the two elongated legs having an inside face and an opposing outside face each extending to a distal terminal end face;
a first slot recessed into the distal terminal end face of each of the two elongated legs so as to extend between the inside face and the outside face; and
the saw blade being disposed within the first slot of each of the two elongated legs.

9. The saw accessory as recited in claim 1, further comprising:
each of the two elongated legs having an inside face and an opposing outside face each extending to a distal terminal end face, a side face extending between the inside face and the outside face;
a second slot recessed into the side face of each of the two elongated legs so as to extend between the inside face and the outside face, the second slot being spaced apart from the distal terminal end face; and
the saw blade being disposed within the second slot of each of the two elongated legs.

10. The saw accessory as recited in claim 1, further comprising:
each of the two elongated legs having an inside face and an opposing outside face each extending to a distal terminal end face, a side face extending between the inside face and the outside face;
a first slot recessed into the distal terminal end face of each of the two elongated legs so as to extend between the inside face and the outside face;
a second slot recessed into the side face of each of the two elongated legs so as to extend between the inside face and the outside face, the second slot being spaced apart from the distal terminal end face; and
the saw blade being disposed within the first slot or the second slot of each of the two elongated legs.

11. The saw accessory as recited in claim 1, wherein the saw blade comprises:
a blade body having a first side face and an opposing second side face that extend between a first end and an opposing second end;
a first pin outwardly projecting from the first side face of the blade body at the first end; and
a second pin outwardly projecting from the second side face of the blade body at the first end.

12. The saw accessory as recited in claim 1, wherein the saw blade comprises a coping saw blade.

13. The saw accessory as recited in claim 1, wherein an opening is directly bounded between the two spaced apart legs and is directly bounded by the saw blade.

14. An oscillating multi-tool assembly comprising:
oscillating power tool comprising:
a body housing a motor; and
a rotor projecting from the body, the rotor being coupled with the motor so that when the motor is activated, the rotor repeatedly oscillates about an axis of rotation over a defined angle; and
the saw accessory as recited in claim 1 removably secured to the rotor.

15. A saw accessory for an oscillating multi-tool, comprising:
an attachment base having a front face and an opposing back face, a mounting opening passing through the attachment base between the front face and the back face;
two spaced apart elongated legs each having a proximal end mounted to the attachment base and an opposing distal end, each of the two elongated legs having an inside face and an opposing outside face each extending to a distal terminal end face, a side face extending between the inside face and the outside face;
a first slot recessed into the distal terminal end face of each of the two elongated legs so as to extend between the inside face and the outside face; and
a saw blade being removably disposed within the first slot of each of the two elongated legs.

16. The saw accessory as recited in claim 15, further comprising a second slot recessed into the side face of each of the two elongated legs so as to extend between the inside face and the outside face, the second slot being spaced apart from the distal terminal end face, the second slot of each of the two elongated legs being configured to receive the saw blade.

17. The saw accessory as recited in claim 15, further comprising means for moving the at least one of the two elongated legs relative to the base so as to adjust a distance between the distal ends of the elongated legs.

18. A method for operating an oscillating multi-tool, the method comprising:
securing the saw accessory as recited in claim 1 to an oscillating multi-tool comprising:
a body housing a motor; and
a rotor projecting from the body, the rotor being coupled with the motor so that when the motor is activated, the rotor repeatedly oscillates about an axis of rotation over a defined angle, the attachment base of the saw accessory being secured to the rotor; and
activating the motor of the oscillating multi-tool so that both the rotor and the saw accessory repeatedly oscillate about the axis of rotation.

19. A method for mounting a saw blade on a saw accessory for an oscillating multi-tool, the saw accessory comprising:
an attachment base having a front face and an opposing back face, a mounting opening passing through the attachment base between the front face and the back face; and
two spaced apart elongated legs each having a proximal end mounted to the attachment base and an opposing distal end;
the method comprising:
pivoting at least one of the two elongated legs relative to the attachment base in a first direction so as to move the distal ends of the two elongated legs closer together;
removably securing a saw blade to the distal end of each of the two elongated legs; and
pivoting the at least one of the two elongated legs relative to the attachment base in a second direction so as to tension the saw blade between the distal ends of the two elongated legs.
